(19) United States
(12) Patent Application Publication
(10) Pub. No.: US 2024/0074360 A1
(43) Pub. Date: Mar. 7, 2024

(54) SOLAR ENERGY RECOVERY AND CONVERSION SYSTEM FOR A GREENHOUSE AND ASSOCIATED METHOD FOR CONTROLLING THE SYSTEM

(71) Applicants: UNIVERSITÉ DE PAU ET DES PAYS DE L’ADOUR, PAU (FR); ECOLE DE TECHNOLOGIE SUPÉRIEURE (ETS), Montréal (CA)

(72) Inventors: Stéphane GIBOUT, Serres-Sainte-Marie (FR); Cédric ARRABIE, Angaïs (FR); Didier HAILLOT, Montréal (CA)

(21) Appl. No.: 18/261,835

(22) PCT Filed: Jan. 24, 2022
(86) PCT No.: PCT/FR2022/050127

§ 371 Date: Jul. 17, 2023

(30) Foreign Application Priority Data
Jan. 27, 2021 (FR) FR2100757

(51) Int. Cl. A01G 9/24; F24S 23/77; F24S 30/425; H02S 40/22; H02S 40/42; H02S 40/44

(52) U.S. Cl. CPC A01G 9/243; F24S 23/77; F24S 30/425; H02S 40/22; H02S 40/425; H02S 40/44; F24S 2030/136

(57) ABSTRACT

The subject matter of the present invention is a solar energy recovery and conversion system for a greenhouse for cultivating plants, the greenhouse comprising a cultivation area, characterized in that the solar energy recovery and conversion system comprises: —a set of reflective panels; —a drive device which is provided to cause the reflective panels to pivot around their longitudinal pivot axis; —at least one solar energy recovery device which is arranged between the roof and the set of reflective panels, so as to recover the solar energy reflected by the reflective panels; —a control unit which is configured to control the drive device according to different operating modes. The invention also relates to a method for controlling the solar energy recovery and conversion system.

### CROSS-REFERENCE TO RELATED APPLICATIONS

The present application is a filing under 35 U.S.C. 371 as the National Stage of International Application No. PCT/FR2022/050127, filed Jan. 24, 2022, entitled “SOLAR ENERGY RECOVERY AND CONVERSION SYSTEM FORA GREENHOUSE, GREENHOUSE AND ASSOCIATED METHOD FOR CONTROLLING THE SYSTEM,” which claims priority to French Application No. 2100757 filed with the Intellectual Property Office of France on Jan. 27, 2021, both of which are incorporated herein by reference in their entirety for all purposes.

### TECHNICAL FIELD OF THE INVENTION

The present invention relates to a solar energy recovery and conversion system for a greenhouse allowing the production of plants and a method for controlling the system.

### TECHNICAL BACKGROUND

A majority of existing greenhouses have a shape of the tunnel or gothic arch type. The greenhouse comprises a framework, or support structure, for example made by means of metal rods, which support a transparent roof. The transparent roof can be produced by means of transparent walls, for example made of polyethylene or of polycarbonate or of glass.

One disadvantage of existing greenhouses is that they do not allow optimal thermal regulation. Depending on the amount of sunshine, it may be difficult to keep the temperature inside the greenhouse at a level suitable for the production of plants.

In addition, greenhouses can be energy intensive, for example to cool the greenhouse when the sun is too strong, or to heat the greenhouse when the nights are too cold.

The present invention aims to overcome the problems mentioned above by proposing a solution for recovering solar energy received by the greenhouse, which is more efficient and more economical than the existing solutions.

### SUMMARY OF THE INVENTION

The invention proposes a greenhouse for the cultivation of plants comprising a framework that supports a transparent roof, the greenhouse comprising a cultivation area located under the roof and a solar energy recovery and conversion system, characterized in that the solar energy recovery and conversion system comprises:
a set of reflective panels arranged under the roof and above the cultivation area so as to be able to cover all or part of the cultivation area, each reflective panel being pivotably mounted about a longitudinal pivot axis so as to be able to occupy at least one blackout position parallel to the cultivation area, and several inclined positions;
a drive device that is provided to cause the reflective panels to pivot around their longitudinal pivot axis;
at least one solar energy recovery device which is arranged between the roof and the set of reflective panels, so as to recover the solar energy reflected by the reflective panels;
a control unit that is configured to control the drive device according to the following operating modes:
i) a first operating mode wherein at least one group of reflective panels is controlled in an inclined oblique position in a direction substantially parallel to the solar rays, the drive device varying the inclination of the reflective panels of the group as a function of the course of the sun, so as to maximize the amount of solar rays reaching the cultivation area,
ii) a second mode of operation wherein each reflective panel of the group of reflective panels is controlled individually in an inclined concentration position aiming to concentrate the solar rays that are reflected toward the solar energy recovery device;
iii) a third operating mode wherein the reflective panels of the group of reflective panels are all controlled in a blackout position parallel to the cultivation area.

The invention makes it possible to fulfill several simultaneously objectives since it allows both better thermal regulation inside the greenhouse, electrical and/or thermal energy production as well as possible storage thereof. The invention therefore makes it possible to envisage the construction of greenhouses that are self-sufficient with respect to energy.

According to other features of the invention:
the solar energy recovery device comprises at least one photovoltaic panel making it possible to convert solar radiation into electrical energy;
the solar energy recovery device comprises at least one solar thermal collector making it possible to convert the solar radiation into thermal energy via a heat-transfer fluid;
the solar energy recovery device comprises a storage device which makes it possible to store the electrical energy or the thermal energy produced by the photovoltaic panel or by the solar thermal collector after conversion of the solar radiation;
the greenhouse comprises a thermal regulation device that uses the electrical or thermal energy produced by the solar energy recovery device to regulate the temperature inside the greenhouse;
the roof comprises at least two faces which join together in a longitudinal ridge, a south face being provided to be oriented generally toward the south, a north face being provided to be oriented generally toward the north, and the solar energy recovery device extends longitudinally under the north face;
the solar energy recovery device is arranged near the lower part of the north face,
each photovoltaic panel comprises a cooling device arranged against its rear face, on the side opposite the reflective panels, this cooling device comprising an enclosure making it possible to flow a cooling fluid directly in contact with said rear face.

The present invention also proposes a method for controlling a solar energy recovery and conversion system equipping a greenhouse according to one of the preceding features, characterized in that it comprises the following operating modes:
i) a first operating mode wherein at least one group of reflective panels is controlled in an inclined oblique position in a direction substantially parallel to the solar rays, the drive device varying the inclination of the reflective panels as a function of the course of the sun, so as to concentrate the solar rays toward the cultivation area,
ii) a second operating mode wherein each reflective panel of the group of reflective panels is individually controlled in an inclined concentration position aiming to direct at least a portion of the solar rays that are reflected toward the solar energy recovery device;
iii) a third operating mode wherein the reflective panels of the group of reflective panels are all controlled in a blackout position parallel to the cultivation area,
and in that it comprises the following steps:
a) determining the needs of the plants placed in the cultivation area in terms of solar energy;
b) selecting one of the operating modes as a function of requirements determined in step a).

According to an advantageous feature of the method, when the second operating mode is selected, the following steps are implemented:
c) determining the needs of the greenhouse in terms of thermal energy and electrical energy;
d) tilting each reflective panel according to an orientation that makes it possible to distribute the reflected solar rays toward the solar energy recovery device as a function of the needs determined in step c), the solar energy recovery device comprising a solar thermal collector and a photovoltaic panel.

According to another advantageous feature, when the second operating mode is selected, a step of cooling the photovoltaic panels is carried out during which a cooling fluid is circulated on the rear face of the photovoltaic panels, in direct contact with said rear face.

The present invention also proposes a method for controlling a solar energy recovery and conversion system associated with the greenhouse described above, the method comprising the reception of a climate indicator according to the geographical location of the green; the reception of a desirable cultivation condition indicator according to the type of planting to be cultivated in a washing area of the greenhouse, and the control of the inclination of at least one group of reflective panels of the greenhouse according to the climate indicator and according to the desirable cultivation condition indicator so as to either:
direct at least a portion of the solar rays toward the cultivation area;
direct at least a portion of the solar rays to a solar energy recovery device of the greenhouse, or
form a blackout wall for adjusting the temperature of the cultivation area either by preventing thermal radiation from the cultivation area from escaping to the roof, or preventing at least some of the solar rays from reaching the cultivation area.

### BRIEF DESCRIPTION OF THE FIGURES

Further features and advantages of the invention will become apparent from the following detailed description, which may be understood with reference to the attached drawings wherein:

FIG. 1 is a perspective view schematically showing a greenhouse equipped with reflective panels according to the teachings of the invention;

FIG. 2 is a front view showing the greenhouse of FIG. 1 when the reflective panels occupy a blackout position;

FIG. 3 is a view similar to that of FIG. 2 which shows the greenhouse of FIG. 1 in a first operating mode, when the reflective panels are controlled in an inclined oblique position;

FIG. 4 is a view similar to that of FIG. 2 which shows the greenhouse of FIG. 1 in a first variant of a second operating mode, when the reflective panels are controlled in a first inclined concentration position;

FIG. 5 is a view similar to that of FIG. 2 which shows the greenhouse of FIG. 1 in a second variant of the second operating mode, when the reflective panels are controlled in a second inclined concentration position;

FIG. 6 is a view similar to that of FIG. 2 which shows the greenhouse of FIG. 1 in a third variant of the second operating mode, when the reflective panels are controlled so as to distribute the solar rays in several directions;

FIG. 7 is a block diagram which shows a method for controlling the solar energy recovery and conversion system equipping the greenhouse of FIG. 1;

FIG. 8 is a block diagram which shows a method for controlling the solar energy recovery and conversion system associated with the greenhouse of FIG. 1;

FIG. 9 is a schematic view of a detail of FIG. 4 which shows a cooling device arranged against photovoltaic panels equipping the greenhouse of FIG. 4.

### DETAILED DESCRIPTION OF THE INVENTION

In the following description, identical, similar or analogous elements will be referred to by the same reference numbers.

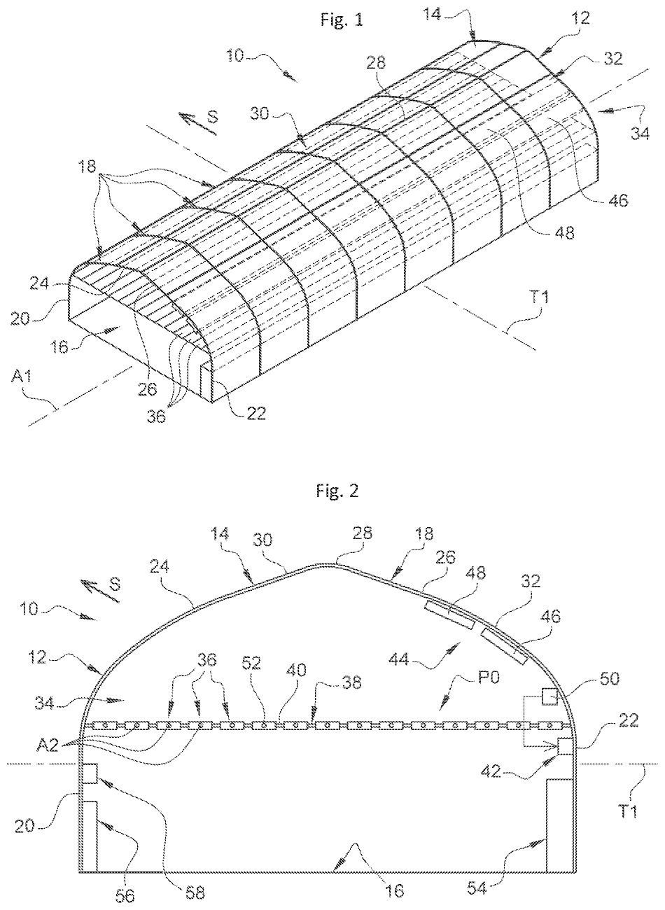

FIG. 1 shows a greenhouse 10 for the cultivation of plants. The greenhouse 10 comprises a framework 12 which supports a transparent roof 14 and a cultivation area 16 located under the roof 14.

The term “transparent” for the roof 14 should not be interpreted here in a restrictive manner. The roof 14 may for example be totally transparent or partially transparent.

The cultivation area 16 extends here over the majority of the floor surface of the greenhouse 10. The cultivation area 16 is provided for the production of plants. According to the embodiment shown, the greenhouse 10 is of the gothic arch type. The framework 12 here comprises a series of arches 18 which are aligned along a longitudinal direction A1 to form an arch.

Each arch 18 comprises two main pillars 20, 22 and two arcs 24, 26 which join in the highest part of the roof 14 by forming the ridge 28. The roof 14 therefore comprises two inclined faces, one on either side of the ridge 28.

Of course, the invention also applies to other greenhouse models, for example a greenhouse 10 comprising an inclined face and/or inner pillars.

In the following description, a longitudinal orientation is used in the longitudinal direction A1 and a transverse orientation T1 relative to the longitudinal direction A1.

Advantageously, the greenhouse 10 is oriented relative to the cardinal points such that a first face of the roof 14, called the south face 30, is oriented generally toward the south S and that a second face of the roof 14, called the north face 32, is oriented north.

The greenhouse 10 comprises a solar energy recovery and conversion system 34 which is produced according to the teachings of the invention.

Thus, the solar energy recovery and conversion system 34 comprises a set of reflective panels 36 which are arranged under the roof 14, above the cultivation area 16. According to the embodiment shown, the reflective panels 36 are mounted on a support structure 38, which is generally planar and horizontal, arranged at the junction between the arcs 24, 26 and the pillars 20, 22. The support structure 38 comprises, for example, transverse beams 40.

Each reflective panel 36 here has a generally rectangular shape and extends in a longitudinal plane. Each reflective panel 36 is pivotably mounted, relative to the support structure 38, about a longitudinal pivot axis A2. When all the reflective panels 36 occupy a horizontal position, referred to as the blackout position P0, that is to say that they extend parallel to the cultivation area 16, as shown by FIGS. 1 and 2, they form a blackout cover above the cultivation area 16 preventing the majority of the solar radiation RS from reaching the cultivation area 16.

Here “blackout cover” means a configuration wherein the reflective panels 36 occupy the position wherein they block the passage of the radiation RS as much as possible. The resulting blackout may be total or partial.

A drive device 42 for example using an electric motor is connected to each reflective panel 36. This drive device 42 is provided to individually control the pivoting of each reflective panel 36 so as to orient it in a determined angular position relative to the solar radiation RS. This drive device 42 makes it possible to adjust the position of the reflective panels 36 individually or in groups.

Advantageously, the reflective panels 36 have a reflective coating on each of their faces.

The solar energy recovery and conversion system 34 also comprises a solar energy recovery device 44 which is arranged between the roof 14 and the set of reflective panels 36.

According to the embodiment shown here, the solar energy recovery device 44 comprises a series of photovoltaic panels 46 making it possible to convert the solar radiation RS into electrical energy. These photovoltaic panels 46 are preferably arranged under the north face 32 of the roof 14, in the lower part of the north face 32. They are for example mounted on the framework 12 so as to follow the slope of the north face 32 and so as to face the set of reflective panels 36. These photovoltaic panels 46 are provided to recover the solar rays reflected by the reflective panels 36 so that the receiving surface of each photovoltaic panel 46 is turned toward the set of reflective panels 36. This geometry makes it possible to obtain a solar concentration that can increase the density of the received radiative flow (high flow) and reduce the capture surface (thermal and/or photovoltaic) while retaining the same production.

Here, the photovoltaic panels 46 are aligned longitudinally and extend here over the entire length of the roof 14.

According to one alternative embodiment, the solar energy recovery device 44 may comprise a single photovoltaic panel 46.

Advantageously, the solar energy recovery device 44 also comprises a series of solar thermal collectors 48 which make it possible to convert the solar radiation RS into thermal energy via a heat transfer fluid. The solar thermal collectors 48 here have the form of panels and are mounted parallel to the photovoltaic panels 46, over the entire length of the roof 14. Here they are mounted on the framework 12, just above the photovoltaic panels 46, so that the receiving surface of each solar thermal collector 48 is turned toward the set of reflective panels 36 to recover the solar rays reflected by the reflective panels 36.

According to one alternative embodiment, the solar energy recovery device 44 may comprise a single solar thermal collector 48.

It is noted that the solar energy recovery device 44 is offset on the lower part of the north face 32 of the roof 14 so as not to cast a shadow on the cultivation area 16 and thus allow the cultivation area 16 to be able to receive all the solar radiation RS coming directly from the sun, when the orientation of the reflective panels 36 allows it. The solar energy recovery and conversion system 34 also comprises a control unit 50 which is configured to control the drive device 42 according to several operating modes.

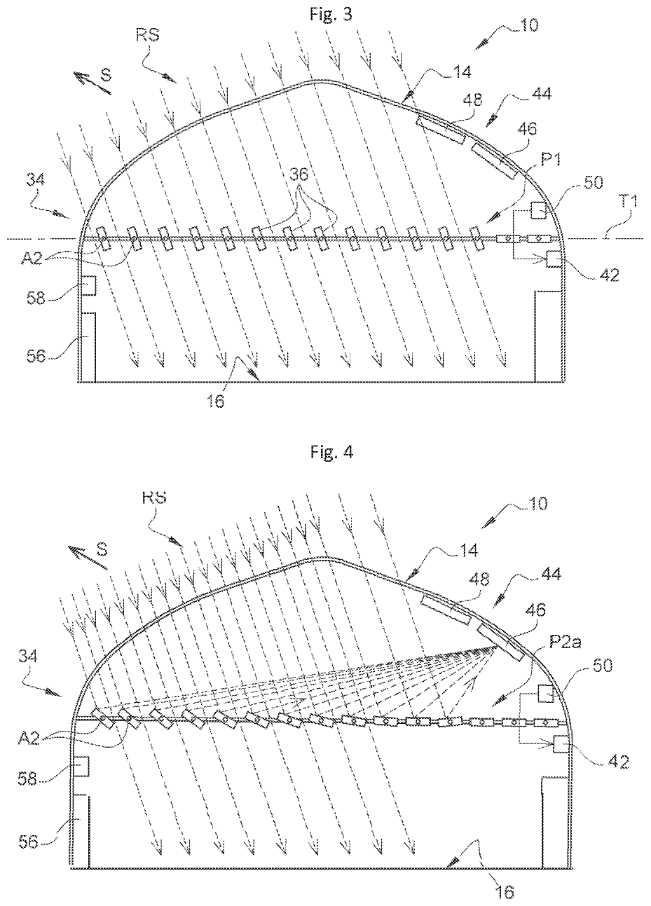

According to a first operating mode M1, which is shown by FIG. 3, the reflective panels 36 are ordered into an inclined oblique position P1 in a direction D1 substantially parallel to the solar rays. To this end, the control unit 50 regularly determines, as a function of the course of the sun, the angle of inclination of the solar rays relative to the floor, or to the cultivation area 16, and adjusts the angular position of the reflective panels 36 so that these reflective panels 36 are generally parallel to the solar rays.

This first operating mode M1 aims to maximize the amount of solar radiation RS reaching the cultivation area 16.

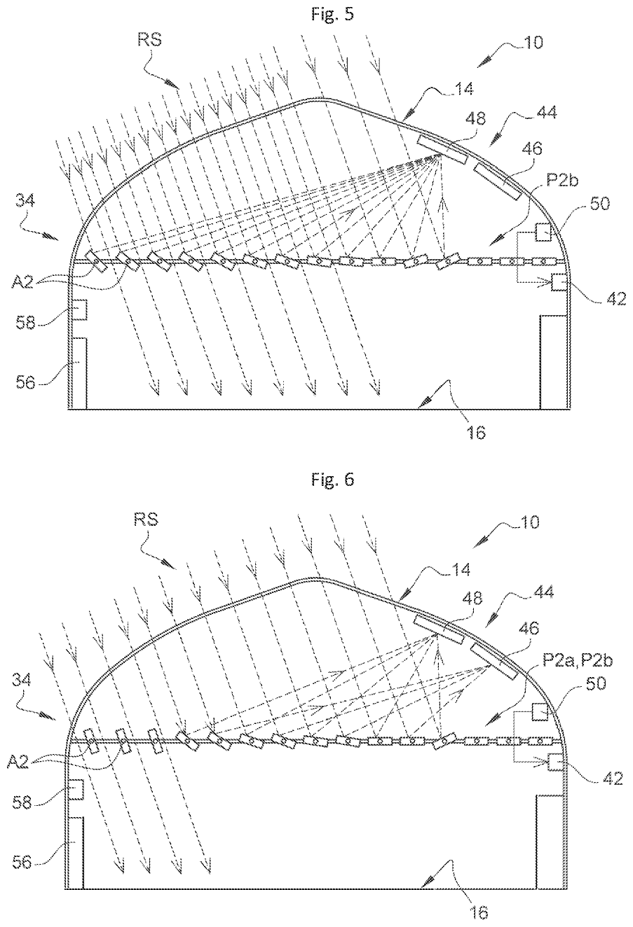

According to a second operating mode M2, which is shown by FIGS. 4 and 5, each reflective panel 36 is ordered into an inclined position with a concentration P2 aimed at maximizing the quantity of solar rays which are reflected toward the solar energy recovery device 44.

According to a first variant M2a of the second operating mode M2, which is shown by FIG. 4, the control unit 50 orients the reflective panels 36 in a first inclined concentration position P2a which makes it possible to concentrate the solar rays reflected on the photovoltaic panels 46. Just as with the first operating mode M1, the control unit 50 regularly determines the angle of inclination of the solar rays relative to the floor, and adjusts the angular position of each reflective panel 36 so that the solar rays which are reflected on its upper reflection face 52 are deflected toward the receiving surface of the closest photovoltaic panel 46, that is to say that which is transversely opposite.

As can be seen in FIG. 4, at a determined instant, the angle of inclination of each reflective panel 36 relative to the horizontal varies progressively as a function of the distance separating each reflective panel 36 from the closest photovoltaic panel 46, or from the transverse distance separating the reflective panel 36 from a lateral longitudinal wall of the greenhouse 10.

The set of reflective panels 36 here functions as a solar energy concentrator which makes it possible to maximize the solar energy received by the photovoltaic panels 46, which makes it possible to maximize the amount of electrical energy produced by the solar energy recovery device 44.

According to a second variant M2b of the second operating mode M2, which is shown by FIG. 5, the control unit 50 orients the reflective panels 36 in a second inclined concentration position P2b which makes it possible to concentrate the solar rays reflected on the photovoltaic panels 48.

The operation according to this second variant M2b is therefore similar to that of the first variant M2a with the difference that the concentration of the reflected solar rays is directed toward the solar thermal collectors 48 instead of the photovoltaic panels 46.

According to a third variant M2c of the second operating mode M2, which is shown by FIG. 6, the control unit 50 distributes the solar rays reflected both toward the photovoltaic panels 46 and toward the solar thermal collectors 48. This third variant M2c makes it possible in particular to regulate the amount of solar energy converted into electrical energy and the quantity of solar energy converted into thermal energy. This third variant M2c also makes it possible to allow part of the light rays to pass towards the cultivation area 16 so as to contribute both to the production of plants and to the production of electrical and thermal energy.

According to a third embodiment M3, which is shown by FIG. 2, the reflective panels 36 are all ordered into their blackout position P0 by the control unit 50. This blackout position P0 in particular makes it possible to retain the heat in the greenhouse 10 at the cultivation area 16, preventing the thermal radiation from escaping toward the roof 14. This blanking position P0 also makes it possible to regulate the temperature inside the greenhouse 10 by minimizing the increase in temperature at the cultivation area 16 when the solar energy is too strong.

Advantageously, the solar energy recovery device 44 comprises a storage device 54 which makes it possible to store the electrical energy and the thermal energy produced by the photovoltaic panels 46 or by the solar thermal collectors 48 after conversion of the solar radiation RS. This storage device 54 comprises, for example, electric batteries making it possible to store the electrical energy and thermal batteries making it possible to store the thermal energy, for example in the form of a hot or cold fluid.

Advantageously, the greenhouse 10 comprises a thermal regulation device 56 that uses the electrical and/or thermal energy produced by the solar energy recovery device 44 to regulate the temperature inside the greenhouse 10. The thermal regulation device 56 comprises, for example, radiators making it possible to maintain the temperature in the greenhouse 10 at a sufficient level for the comfort of the plants grown in the cultivation area 16, in particular at night. Preferably, the greenhouse 10 is equipped with measuring means 58 which make it possible to determine in particular the temperature inside the greenhouse 10, which allows the control unit 50 to control the thermal regulation device 56 appropriately.

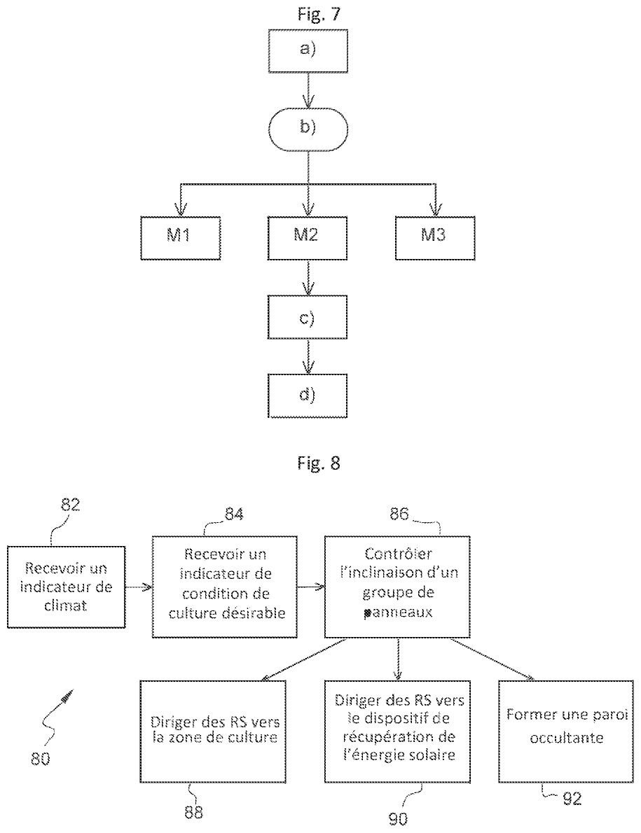

A method for controlling the solar energy recovery and conversion system 34 equipping the greenhouse 10 according to the invention is now described, in particular considering FIG. 7.

The control method comprises a first step a) of determining the needs of the plants placed in the cultivation area in terms of solar energy. During this step, the control unit 50 in particular uses the measuring means 58 to evaluate the conditions of temperature, humidity, and sunshine for plants grown in the cultivation area.

During a second step b), the operating mode most suitable for the needs of the plants is selected by the control unit 50 and implemented.

When the second operating mode M2 is selected, the following steps are implemented:
c) determining the needs of the greenhouse 10 in terms of thermal energy and electrical energy;
d) inclining each reflective panel 36 according to an orientation that makes it possible to distribute the reflected solar rays toward the solar energy recovery device 44 as a function of the needs determined in step c).

Advantageously, when the amount of thermal energy or electrical energy produced by the solar energy recovery device 44 is greater than a predetermined level, or when the amount of thermal energy or electrical energy available in the storage device 54 has reached a predetermined level, the control unit 50 can decide to inject the thermal energy or the electrical energy into a district heating network or into the electrical network of the place where the greenhouse 10 is located.

According to another insemination of the invention, as shown in FIG. 8, there is a method 80 for controlling the solar energy recovery and conversion system 34 associated with the greenhouse 10. The method 80 comprises the reception of a climate indicator 82 according to the geographical location of the greenhouse 10 and the reception of a desirable cultivation condition indicator 84 according to the type of planting to be grown in the cultivation area of the greenhouse. The climate indicator may be a climatic area, an altitude, a temperature, a humidity, a season, or any other type of climate indicator making it possible to characterize the climate environment where the greenhouse is located individually or in combination. The desirable cultivation condition indicator is chosen based on the type of plant to be cultivated and may be a desired temperature, a necessary number of heat units, a necessary level of luminosity, a number of required sunshine hours, any other type of condition necessary for the proper growth of plants to be cultivated, any range thereof or any combination thereof. The climate indicator and the desirable cultivation condition indicator may come from a database, from data input provided by an operator or transmitted by any other system.

The method 80 also comprises the control 86 of the inclination of at least one group of reflective panels 36 of the greenhouse 10 according to the climate indicator and according to the desirable cultivation condition indicator so as to direct 88 at least a portion of the solar rays RS toward the cultivation area 16, as shown in FIG. 3; to direct 90 at least a portion of the solar rays toward the solar energy recovery device 44 of the greenhouse 10, as shown in FIG. 5; form a blackout barrier 92 to adjust the temperature of the cultivation area 16 either by preventing thermal radiation from the cultivation area 16 from escaping toward the roof 14, or by preventing at least a portion of the solar rays RS from reaching the cultivation area 16, as shown in FIG. 2; or any combination thereof. It will be understood that the formation of a blackout barrier may be completely blackout or partially blackout.

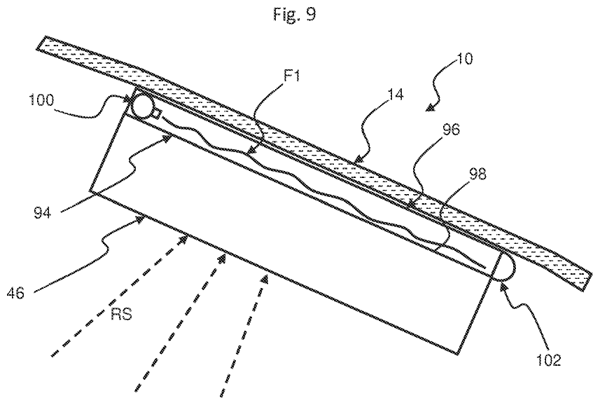

According to a variant embodiment which is schematically shown in FIG. 9, the photovoltaic panels 46 can be equipped with a cooling device 94 by spraying or runoff, which makes it possible to increase the performance of the photovoltaic panels 46 and to avoid overheating. FIG. 9 shows a detail view of the roof 14 of the greenhouse 10, where the photovoltaic panels 46 are installed. The photovoltaic panels 46 are here arranged against the roof 14 but they could be positioned differently.

The cooling device 94 here comprises an enclosure 96 which is arranged against the rear face 98 of the photovoltaic panels 46 and which makes it possible to circulate a cooling liquid, for example water, able to cool the active part of the photovoltaic panels 46.

According to the example shown, the cooling device 94 comprises, in its upper part, a supply duct 100 equipped with nozzles 102 which produce a flow F1 of the cooling fluid directly against the rear face 98 of the photovoltaic panels 46. The inclination of the photovoltaic panels 46 allows a flow by gravity toward the lower part of the cooling device 94 which comprises a collector 102 able to collect the cooling fluid.

The cooling fluid can also be sprayed against the rear face 98 by means of a spraying system (not shown) in order to improve the efficiency of the cooling device 94.

Of course, the cooling device 94 can be connected to a complete cooling circuit and the thermal energy collected by the cooling fluid can be reused by appropriate means.

The cooling device 94 is particularly effective because it allows direct contact between the cooling fluid and the rear face 98 of the photovoltaic panels 46. Unlike solutions using cooling channels arranged on the rear face 98, there are very few constraints related to the expansion of the materials constituting the photovoltaic panels 46 and the cooling device 94.

The method for controlling the solar energy recovery and conversion system 34 equipping the greenhouse 10 advantageously comprises a step of cooling the photovoltaic panels 46 which is implemented with the second operating mode M2, when the photovoltaic panels 46 receive solar rays RS reflected by the reflective panels 36.

In the present description, the term “greenhouse” should be interpreted broadly enough to apply to any type of building wherein the control method according to the invention can be used. This building may in particular have a glazed portion and a non-glazed portion.

### LEGEND

10: greenhouse
12: framework
14: roof
16: cultivation area
18: arch
20, 22: pillars
24, 26: arcs
28: ridge
30: south face
32: north face
34: solar energy recovery and conversion system
36: reflective panel
38: support structure
40: transverse beam
42: drive device
44: solar energy recovery device
46: photovoltaic panel
48: solar thermal collector
50: control unit
52: upper reflection face
54: storage device
56: thermal regulation device
58: measuring means
80: method
82: climate indicator
84: desirable cultivation condition indicator
86: control the inclination of a group of panels
88: direct solar rays toward the cultivation area
90: direct solar rays toward the solar energy recovery device
92: form a blackout barrier
94: cooling device
96: enclosure
98: back face
100: power line
102: collector
A1: longitudinal direction
A2: longitudinal pivot axis
F1: flow
M1: first operating mode
M2: second operating mode
M2a: first variant of the second operating mode
M2b: second variant of the second operating mode
M2c: third variant of the second operating mode
P0: blackout position
P1: inclined oblique position
P2: inclined concentration position
P2a: first inclined concentration position
P2b: second inclined concentration position RS: solar radiation or solar rays
S: south
T1: transverse direction

1. A solar energy recovery and conversion system provided to equip a greenhouse for the cultivation of plants comprising a framework which supports a transparent roof, the greenhouse comprising a cultivation area located under the roof, characterized in that the solar energy recovery and conversion system comprises:
a set of reflective panels arranged under the roof and above the cultivation area so as to be able to cover all or part of the cultivation area, each reflective panel being pivotably mounted about a longitudinal pivot axis so as to be able to occupy at least one blackout position parallel to the cultivation area, and several inclined positions;
a drive device that is provided to cause the reflective panels to pivot around their longitudinal pivot axis;
at least one solar energy recovery device which is arranged between the roof and the set of reflective panels, so as to recover the solar energy reflected by the reflective panels;
a control unit that is configured to control the drive device according to the following operating modes:
i) a first operating mode wherein at least one group of reflective panels is controlled in an inclined oblique position in a direction substantially parallel to the solar rays, the drive device varying the inclination of the reflective panels of the group as a function of the course of the sun, so as to maximize the amount of solar rays reaching the cultivation area,
ii) a second operating mode wherein each reflective panel of the group of reflective panels is individually controlled in an inclined concentration position aiming to concentrate the solar rays that are reflected toward the solar energy recovery device;
iii) a third operating mode wherein the reflective panels of the group of reflective panels are all controlled in a blackout position parallel to the cultivation area.

2. The system according to claim 1, characterized in that the solar energy recovery device comprises at least one photovoltaic panel making it possible to convert solar radiation into electrical energy.

3. The system according to claim 1, characterized in that the solar energy recovery device comprises at least one solar thermal collector making it possible to convert solar radiation into thermal energy via a heat transfer fluid.

4. The system according to claim 2, characterized in that the solar energy recovery device comprises a storage device which makes it possible to store the electrical energy or the thermal energy produced by the photovoltaic panel or by the solar thermal collector after conversion of the solar radiation.

5. A greenhouse for the cultivation of plants comprising a framework which supports a transparent roof, the greenhouse comprising a cultivation area located under the roof, characterized in that it comprises a solar energy recovery and conversion system.

6. The greenhouse according to claim 5, characterized in that it comprises a thermal regulation device that uses the electrical or thermal energy produced by the solar energy recovery device in order to regulate the temperature inside the greenhouse.

7. The greenhouse according to claim 5, characterized in that the roof comprises at least two faces which join into a longitudinal ridge, a south face being provided to be oriented generally toward the south, a north face being provided to be oriented generally toward the north, and in that the solar energy recovery device extends longitudinally under the north face.

8. The greenhouse according to claim 7, characterized in that the solar energy recovery device is arranged near the lower part of the north face.

9. The greenhouse according to claim 5, characterized in that each photovoltaic panel comprises a cooling device arranged against its rear face, on the side opposite the reflective panels, this cooling device comprising an enclosure making it possible to flow a cooling fluid directly in contact with said rear face.

10. A method for controlling a solar energy recovery and conversion system equipping a greenhouse according to claim 5, characterized in that it comprises the following operating modes:
i) a first operating mode wherein at least one group of reflective panels is controlled in an inclined oblique position in a direction substantially parallel to the solar rays, the drive device varying the inclination of the reflective panels as a function of the course of the sun, so as to concentrate the solar rays toward the cultivation area,
ii) a second operating mode wherein each reflective panel of the group of reflective panels is individually controlled in an inclined concentration position aiming to direct at least a portion of the solar rays that are reflected toward the solar energy recovery device;
iii) a third operating mode wherein the reflective panels of the group of reflective panels are all controlled in a blackout position parallel to the cultivation area,
and in that it comprises the following steps:
a) determining the needs of the plants placed in the cultivation area in terms of solar energy;
b) selecting one of the operating modes as a function of requirements determined in step a).

11. The method according to claim 10, characterized in that, when the second operating mode is selected, the following steps are implemented:
c) determining the needs of the greenhouse in terms of thermal energy and electrical energy;
d) tilting each reflective panel according to an orientation that makes it possible to distribute the reflected solar rays toward the solar energy recovery device as a function of the needs determined in step c), the solar energy recovery device comprising a solar thermal collector and a photovoltaic panel.

12. The method according to claim 11, characterized in that, when the second operating mode is selected, a step of cooling the photovoltaic panels is carried out during which a cooling fluid is circulated on the rear face of the photovoltaic panels, in direct contact with said rear face.
